(19) United States
(12) Patent Application Publication
(10) Pub. No.: US 2004/0044597 A1
(43) Pub. Date: Mar. 4, 2004

(54) Tracking system

(76) Inventors: Gillon McLachlan, Glen Iris (AU); Craig Auwardt, Glen Iris (AU)

Correspondence Address: Robert R Sachs, Fenwick & West, Silicon Valley Center, 801 California Street, Mountain View, CA, 94041, US

(21) Appl. No.: 10/333,625

(22) PCT Filed: Jul. 23, 2001
(86) PCT No.: PCT/AU01/00894

(30) Foreign Application Priority Data
Jul. 21, 2000 (AU) PQ 8914

(51) Int. Cl. G06F 17/60

(52) U.S. Cl. 705/28

(57) ABSTRACT

A system for tracking and/or certification of characteristics of assets that may be produced or otherwise created and then transferred between participants in commerce. Tracking tools are created and issued in relation to the assets and are generally modified on occurrence of events such as division, integration, modification or transfer of the assets. Information concerning the assets is contained in the tools and is also held in a registry system. Participants hold tools that are related to assets in their possession and notify the registry as alterations or transfers of the assets and tools take place. The system can be applicable to a wide range of participants, assets and commercial or related activities.

### FIELD OF THE INVENTION

This invention relates to tracking and certification of assets in commerce. Assets are construed broadly to be virtually any tangible or intangible item that can be transferred between participants in a commercial arrangement or related activity. In particular for example, the invention may be implemented for certification purposes in heavy industries such as shipping.

### BACKGROUND TO THE INVENTION

Current systems for certification of many commercial assets are open to error and fraud, and generally lack a tracking mechanism by which the current characteristics of an asset or a related certificate can be readily determined. Assets in this sense include a wide range of potential items from relatively simple objects such as raw or processed materials, to relatively complex entities such as aircraft and ships which can be created from objects or other entities. Certification of objects such as bulk steel, for example, and entities such ships which are made from the steel, is often required by insurance agencies. Certificates are generally issued in the form of paper documents which are transferred manually between participants in a commercial arrangement, or electronically as digital images of the paper documents. Certificates in this form are easily lost, copied or incorrectly linked to their original objects or entities, so that assessments of an entity such as an aircraft engine or wing, or an entire ship, are not necessarily reliable.

Producers of objects, such as steel manufacturers, issue test certificates which specify characteristics of the objects that they produce, for inspection by other parties such as purchasers, and retention of the objects are bought. Objects may be divided and distributed to different purchasers, and their certificates must be reproduced accordingly. For example, a bulk order of steel having particular chemical or physical characteristics may be held at a warehouse, and then divided for smaller orders, perhaps to different countries. Similarly, creators or modifiers of entities, such as aircraft or ship manufacturers, use objects or other entities in manufacturing processes, and also issue certificates which specify characteristics of the entities that they create or modify. Complex entities generally require complex classification and certificates, and these also may be updated or changed in many ways, as when entities are transferred between participants in commercial activities, or are further modified. For example, ships may be bought and sold, may be renovated, or cut up to provide parts for other ships. The related certificates are held by a sequence of participants in the shipping industry.

Certifying authorities, such as ship or aircraft classification societies, authorise the producers, creators and modifiers to issue the certificates in accord with predetermined standards. These standards are often set in accord with the requirements of safety, insurance or government agencies. Permission for a set quantity of production is normally given by an authority in advance of commercial activity and creation of the assets to which the certificates will be applied. The authorities inspect the production and other manufacturing or engineering facilities of each producer, creator and modifier, and may review test data, to ensure that the standards are being met. For example, steel mills and shipyards may be visited by inspectors several times a year on a regular or random basis. Several different authorities may be involved with a particular producer, creator or modifier of objects or entities. The authorities may investigate at any time whether a particular object or entity has an appropriate classification or certificate. They may also reclassify entities from time to time, according to changes in existing standards or to new standards for example, and may require modification or reissue of existing certificates.

Certified objects and entities may be held by a range of different participants in commerce or other parties, for a range of purposes. For example, bulk steel may be bought, divided and sold by a series of organisations before integration in an entity such as a ship or plane. A ship may be transferred from the manufacturer to a series of different owners, operators and renovators. Parties such as a new purchaser of the particular asset, an insurance assessor or a safety controller may require inspection of the certificate from time to time. The certificate can be viewed on request to the current holder under these circumstances, and some additional information may be obtained directly from the certifying authorities.

In conventional certification systems, the only way to track the history of a certified object or entity, is to investigate each step of the purchase and production processes manually. There is no ready way to check current status of objects of entities. There is also no effective control over illicit reproduction of certificates or their diversion to inferior objects or entities. The systems can be expensive to operate because manual processing of the certificates is required.

### SUMMARY OF THE INVENTION

It is therefore an object of the present invention to provide improved systems for tracking characteristics of assets in commerce, or at least to provide an alternative to existing systems. In general terms, the invention provides a system in which tracking tools are created electronically and recorded in a central registry, with details of the tools being updated as the respective assets are transferred, modified, integrated or otherwise used by participants in commerce or related activities, or as standards relating to the assets are changed.

Accordingly in one aspect the invention may broadly be said to consist in a registry system for tracking characteristics of assets produced and transferred by participants in commerce, comprising: a creation subsystem that creates and issues tracking tools as required by participants that initially hold the tools, a storage subsystem that records information relating to tools which have been issued by the creation subsystem, and subsequently modified and/or transferred among participants in relation to the assets, a tracking subsystem that communicates with participants in relation to modification or transfer of tools and assets, and updates the storage subsystem, and a response subsystem that provides information to participants or other parties on request in relation to the current status of tools and characteristics of respective assets.

The invention may further be said to consist in a method of tracking characteristics of assets in commerce comprising: creating and issuing tools as required by participants that initially hold the tools before allocation to assets, storing information in a registry concerning the tools that have been created and issued, receiving information in relation to creation, modification and/or transfer of the assets and tools among participants, and providing information from the registry to other parties in relation to current status of the tools and characteristics of the assets.

The invention may still further be said to consist in a participant system for use in tracking characteristics of assets in commerce, comprising: a storage subsystem that holds tracking tools representing assets currently possessed by the participant, a transfer subsystem that receives and transmits tracking tools in relation to transfer of the assets to and from other participants, and a notification subsystem that communicates changes in the tracking tools made by the participant to a registry.

In another aspect the invention may be said to consist in a method for a participant in a tracking system comprising: storing tracking tools representing assets currently possessed by the participant, transmitting tracking tools in relation to transfer of the assets to and from other participants, and notifying a registry regarding changes in the tracking tools made by the participant.

The term “asset” in this specification is interpreted broadly to include a range of objects and entities, whether tangible or intangible, such as goods and services, materials of all kinds, large and small devices, vehicles or items that might not normally be called goods, legal rights, academic qualifications, software applications and so on. Different kinds of tracking tools may be created and issued for different kinds of assets, as required. In general terms, tools created in relation to objects are called “tokens”, while those in relation to entities are called “shells”.

### LIST OF FIGURES

Preferred embodiments of the invention will be described by way of example, with respect to the accompanying figures, of which:

FIG. 1 shows a simple tracking and certification system for objects,

FIGS. 2a, 2b, 2c show a tracking token at various stages in the system of FIG. 1,

FIG. 3 shows a more complex tracking system for objects and entities,

FIGS. 4a, 4b, 4c, 4d show a tracking shell at various stages in the system of FIG. 3,

FIG. 5 summarises movement of a typical tracking tool in a simple certification system,

FIG. 6 shows division of a tracking tool in part of a tracking system,

FIGS. 7a, 7b, 7c show a tracking token at various stages in FIG. 6,

FIG. 8 shows combination of tracking tools in part of a tracking system,

FIGS. 9a, 9b, 9c show tokens and shells at various stages in FIG. 8,

FIGS. 10a, 10b show modification of a shell held by a participant in a tracking system,

FIG. 11 indicates token data for a sheet steel object,

FIG. 12 indicates shell data for a ship entity,

FIG. 13 schematically shows a computer system for a typical registry in a tracking system,

FIG. 14 shows a computer system for a typical authority in a tracking system,

FIG. 15 shows a computer system for a typical producer of objects,

FIG. 16 shows a computer system for a typical creator or modifier of entities,

FIG. 17 shows a computer system for a typical holder of assets or tracking tools other than an authority, producer or other mentioned above, and

FIG. 18 shows a typical system operated by an interested party seeking information about assets and their tracking tools.

### DETAILED DESCRIPTION OF PREFERRED EMBODIMENTS

Referring to these drawings it will be appreciated that the invention may be implemented in many forms for participants in many commercial arrangements or similar activities. Tracking systems according to the invention may be used to track and certify the characteristics of a wide range of assets, generally described here as objects or entities. Tracking tools corresponding to assets of these kinds are generally termed tokens or shells as an approximate indication of their complexity. However, a wide range of assets, objects, entities, tools, tokens and shells or other similar items may be implemented in practice, for a range of participants. Details of computer or communication systems that are mentioned in the specification will be understood by skilled readers and need not be described in detail.

FIG. 1 schematically shows a simple tracking system involving a central registry, a certifying authority, an issuer of certificates in relation to objects, a holder of objects and an assessor of the objects. The authority could be a metal classification or certification organisation, an institution setting the nature of academic qualifications, a software standards body, or any number of different participants in an overall arrangement for creation of objects. The issuer could be a steel producer, a university, a software house, a safety inspection company and so on, in which case the objects may respectively be raw steel, a university degree, a software application or an inspection result. There will usually be many different kinds of objects such as steel beams of different dimensions and compositions, graduate or postgraduate degrees and so on. The holder could then be steel warehouse operator, a student at the university, a computer user or an owner of inspected premises, for example. The assessor could respectively be a potential purchaser of steel, an employer, a client of the software house, a resident of the premises. The nature of the system is clearly not limited by these simple examples.

In FIG. 1, the authority has determined a number of tracking tools that may be required for purposes in the near future, or has a specific need for tools in relation to particular objects or other assets. Generally on request by the authority, the registry creates and issues tokens which are then held by the authority until required. Tools such as tokens are generally data in some form such as records or electronic documents stored on a computer system licensed from the registry, and transmitted over a communication network such as the Internet as will be described below. A producer intending to manufacture and sell objects of a kind controlled by the authority, requests a batch of tokens in accord with the authority requirements. Many producers may interact with the authority in this way, although only one has been shown here for clarity. The producer is generally intending to issue a certificate with each object, or with groups of objects, so different kinds of tokens may be created and issued by the authority together, to a range of producers. Each certificate is generally based on a token. A producer uses tokens over a period of time and produces objects that are delivered to a holder such as a warehouse. Tokens are transferred by the producer to the holder approximately simultaneously with shipment or other transfer of the objects. The assessor such as a purchaser may enquire regarding objects held by the holder, and receive information either from the holder or from the registry.

Transfer of tokens between participants in FIG. 1 is generally indicated by a one way arrow, although tokens may in some instances be returned to their source. Tokens are generally modified by each participant before passage to another participant, to indicate actions in that particular part of the tracking system, as described below. The registry maintains a database of tools in the system, and updates information concerning changes to each tool when a transfer is made between participants. Modification of tools is a process controlled by the registry and should only be carried out using software licensed by the registry to the particular participant. The tools are held in encrypted databases on computer systems operated by the participants, and are transferred between systems by encrypted transmissions, using Secure Sockets Layer (SSL) for example. Communications by the participant to the registry confirming the modifications, and between participants confirming despatch and receipt of tokens, are indicated by double ended arrows. They may or may not be encrypted but generally should be secured wherever possible. Communications generally take place over a network such as the Internet, and a wide range of interactions are possible in practice.

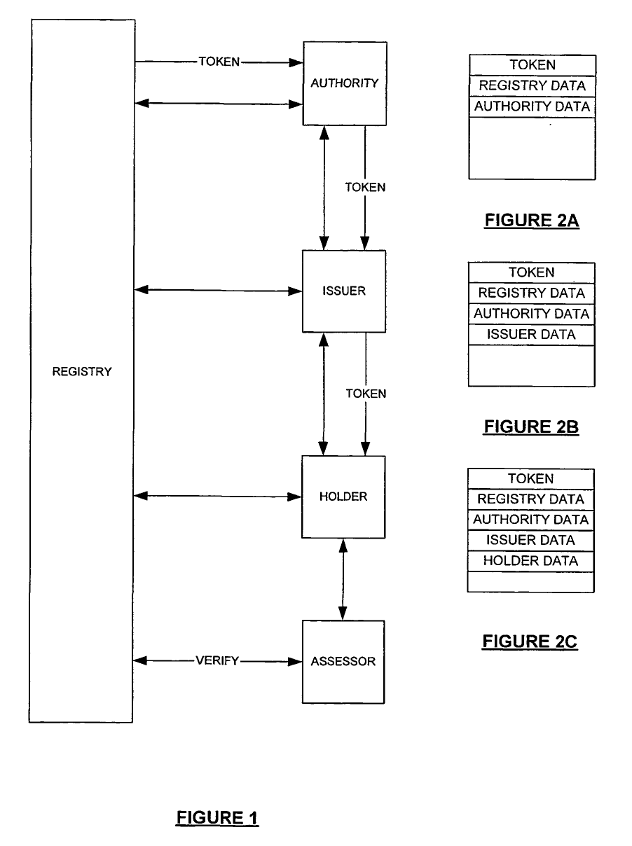

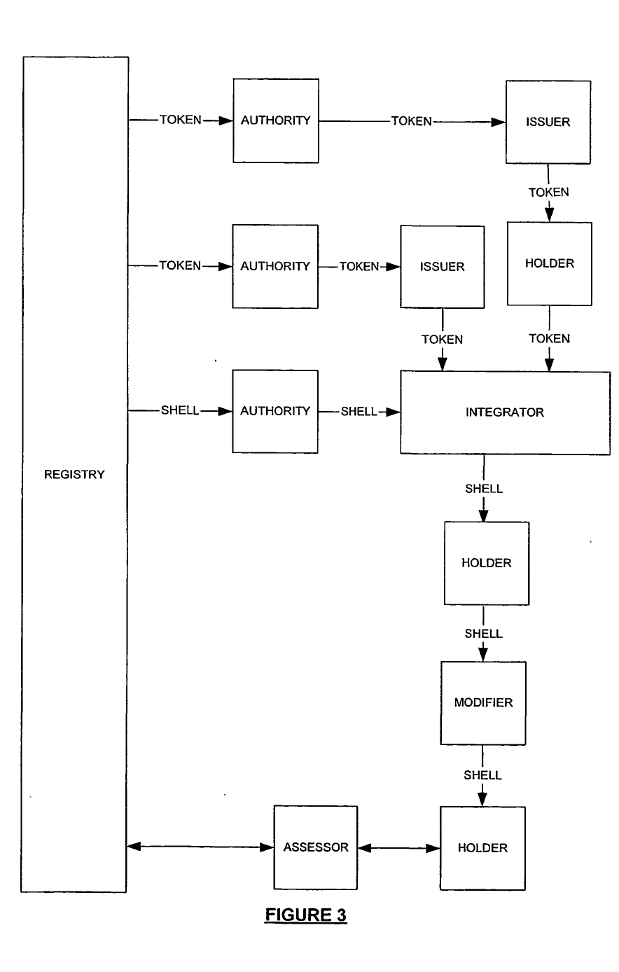

FIGS. 2a, 2b, 2c indicate a simple token at three stages of the tracking system. FIG. 2a shows the general form of a token as possessed by the authority, containing data imparted by the registry on creation of the token, including data relating to the registry and data relating to the authority to which the token is sent. FIG. 2b shows the token as possessed by the issuer. Data relating to the issuer and the kinds of objects in relation to which the token is permitted to be used has generally been added by the authority before transmission to the issuer. FIG. 2c shows the token as held at the holder, including data added by the issuer before transmission to the holder. At each stage of transfer of a tool between the participants, changes are communicated to the registry and corresponding changes are made in the database operated by the registry. Additional information that is not part of the tool may also be transmitted to the registry for inclusion on the database, such as details relating to transfer of the assets themselves. Preferably the tools do not become unnecessarily large by inclusion of relatively unimportant data. The assessor is able to communicate with the holder regarding the object, and to verify the information held in the tool by enquiry and response from the registry.

FIG. 3 shows a more complicated tracking system involving additional participants, assets and tools. Most communications between the participants and between the participants and the registry have been omitted for clarity. These are generally updates for the registry database, and confirmations of despatch and receipt as described above. An integrator or creator of entities such as a manufacturer of aircraft or ships, or of components for aircraft for ships, receives objects from two issuers, usually via one or more holders such as distributors, in this simple example. The integrator must normally operate in relation to an authority, such a ship classification society, and receives appropriate tracking tools from the authority. Tools for entities are generally more complex than those for objects, and a distinction between tokens and shells has therefore been drawn in this description. Various kinds of tools may exist in practice. Two other authorities also receive tokens from the registry in relation to objects produced by a range of issuers. Each authority is shown in relation to a single issuer for clarity. The authorities may be classification societies for metal components and glass components of a ship or an aircraft for example, and the issuers may be manufacturers of metal or glass intending to produce and certify particular objects for their customers. The integrator receives shells from its relevant authority, objects and tokens from the issuers or holders, and creates entities. Each entity is created in relation to a shell that combines information from the tracking tools for the component objects. In more complex cases entities may be formed from both objects and/or other entities.

A further participant in the system of FIG. 3 is a modifier. Entities created by the integrator may be completed and despatched to a modifier for further work. For example, a ship may be sent to another shipyard for special fittings. A modifier may also act in relation to an authority, and require permission from the authority, although this has not been shown. The modifier receives a tool in the form of a shell from the integrator or a holder. Eventually an entity such as ship or aircraft is owned or leased by a holder such as an operator who also receives the respective shell. An assessor such as employed by an insurance agency may be asked to provide an insurance policy for the entity in which case, an enquiry to the registry will reveal information about the history and current status or the entity. Another assessor might be a port authority checking suitability of the ship to enter harbour. It is clear that many variations on this example are possible, and more realistic in commerce. There will normally be multiple authorities, issuers, integrators, holders, modifiers and assessors in relation to a particular entity such as a ship or aircraft. Various terminology may be used to describe the activities of the participants, so that an issuer might be termed a producer, manufacturer or certifier, an integrator may be called a creator or a builder for example, while a holder might be termed an owner, operator, distributor or a user. An assessor might be termed a monitor or an observer. The authority and the registry would also normally have more specific names in practical circumstances.

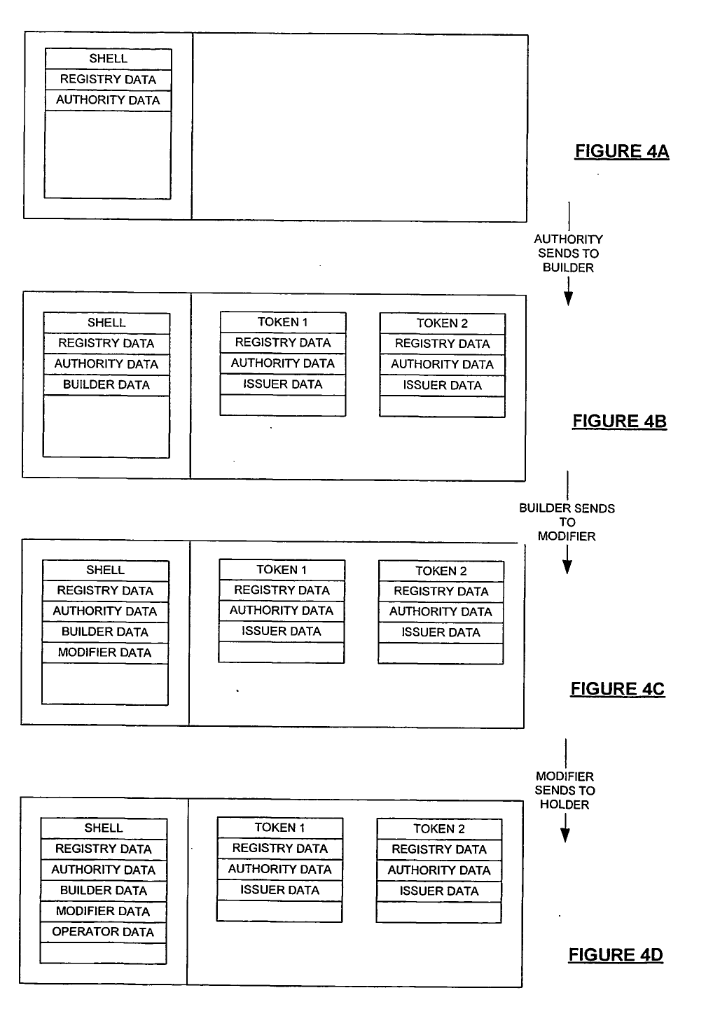

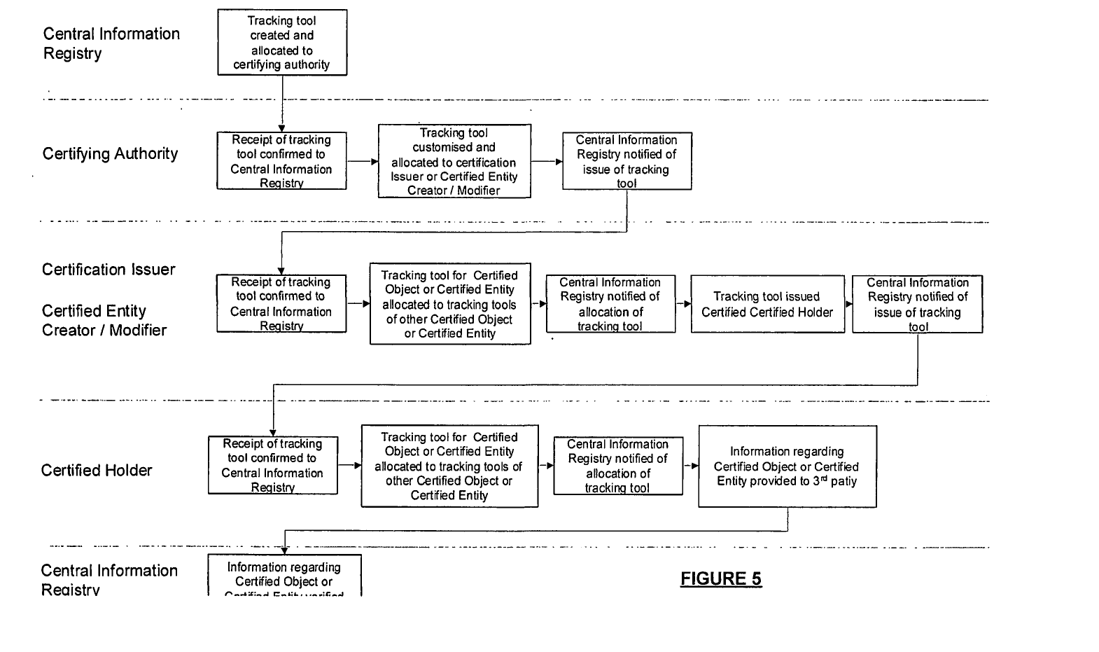

FIGS. 4a, 4b, 4c and 4d indicate a simple shell at four stages of the tracking system. In this example the shell relates to an entity formed by combination of two objects each represented by a token. FIG. 4a represents the shell as might be received by an authority from the registry, containing data relating to the registry, and to the authority for which the shell has been created. FIG. 4b represents the shell as possessed by the integrator or builder from the authority, containing information about the builder, also the tokens and therefore the objects from which the builder is permitted to create the entity. FIG. 4c represents the shell as received by a modifier from the builder containing information about the modifier and actions permitted by the modifier in relation to the entity. Also the tokens from which the entity was created. FIG. 4d represents the shell as received by a holder after modification. The modifier has included data relating to the operator before transfer of the entity and shell to the operator.

FIG. 5 is flow diagram representing passage of a sequence of activities relating to a tracking tool in a simple tracking system such as shown in FIG. 1 or 3. A corresponding asset is assumed to be transferred substantially simultaneously with the tool following the issuer. In this example the system is specifically intended for certification purposes and the participants are expressed accordingly. The registry creates and issues a tool as required by an authority, and stores a record of the tool in a database. The authority confirms receipt, stores and customises the tool as required for a particular issuer or other participant such as an integrator or modifier. Details of the customisation are sent to the registry. The registry is notified by the authority when the tool is despatched to the issuer. On receipt of the tool by the issuer or other party, confirmation is sent to the registry. The tool is allocated to a particular object or entity during the course of production and details are sent to the registry. Eventually the tool is issued to a holder or another participant when the object or entity is transferred, and the registry is again notified. On receipt of the tool by the holder confirmation is sent to the registry. Further allocation of the tool may take place with details sent to the registry. An enquiry from an interested party such as an insurance assessor is met initially by the holder. The assessor may then verify the information provided by holder regarding the object or entity at the registry.

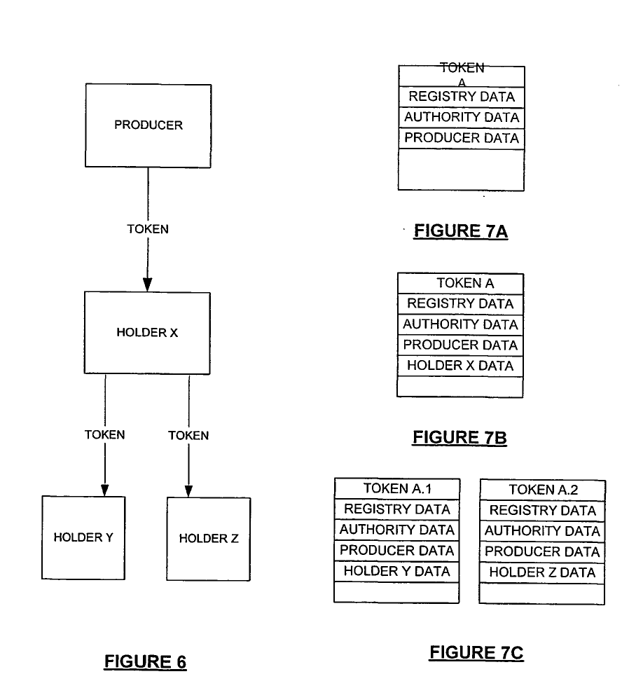

FIG. 6 shows part of a tracking system in which a tool, in this case a token, is split on division of a corresponding object or group of objects. FIGS. 7a, 7b, 7c show a simplified token at each step of the process. A producer manufactures an object in accord with token A in FIG. 7a. The token is altered in relation to holder X as shown in FIG. 7b, and both object and token are transferred by the producer to holder X. Notifications to the registry are sent as usual. The holder in this case may be a distributor that divides a stack of steel plates in order to supply two other holders Y and Z, for example. Holder X generates two versions of token A with data relating to each of the two holders, and transfers the tokens and the divided objects to the respective holders, with notifications to the registry as usual. FIG. 6c shows tokens A.1 and A.2 as received by the two holders.

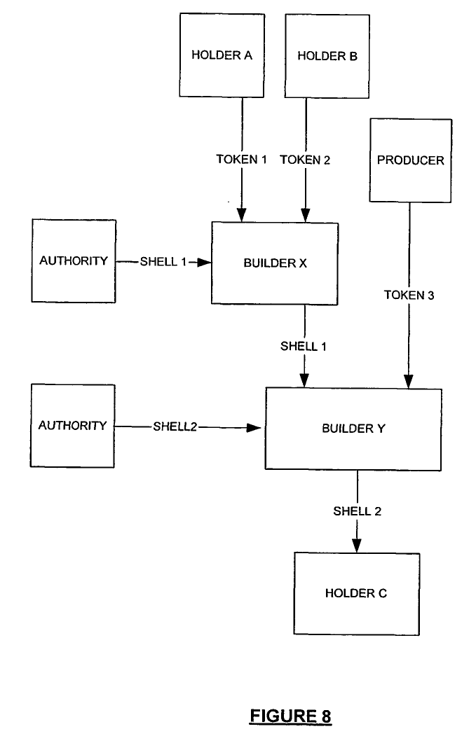

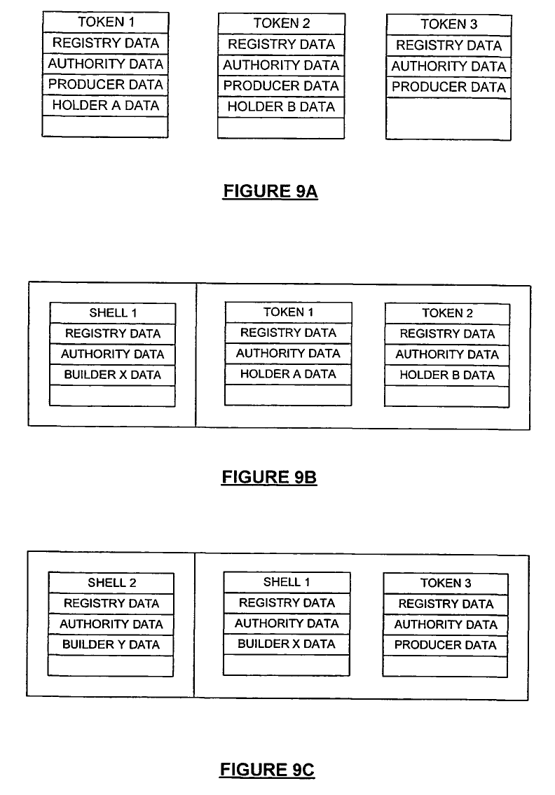

FIG. 8 shows part of a tracking system in which two tools of different kinds, in this case a token and a shell are combined. FIGS. 9a, 9b, 9c show a simplified tool at important steps of the process. Holders A and B provide tokens 1 and 2, with corresponding objects, to builder X. A producer provides token 3 and a corresponding object to builder Y. The tokens at this stage are indicated in FIG. 9a. Authorities provide shells 1 and 2 to builders X and Y in relation to predetermined entities that the builders will create. FIG. 9b indicates shell 1 on construction of the respective entity using the objects from holders A and B. Builder Y receives shell 1 and the entity from builder B, with token 3 and an object from the producer. Builder Y then creates another entity in accord with shell 2. FIG. 9c indicates shell 2 on construction of the second entity, as would be transferred to a subsequent participant such as an operator.

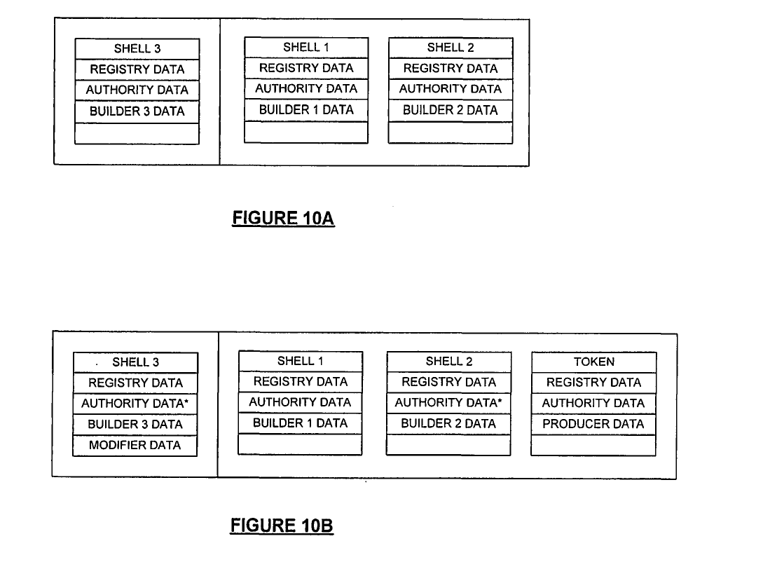

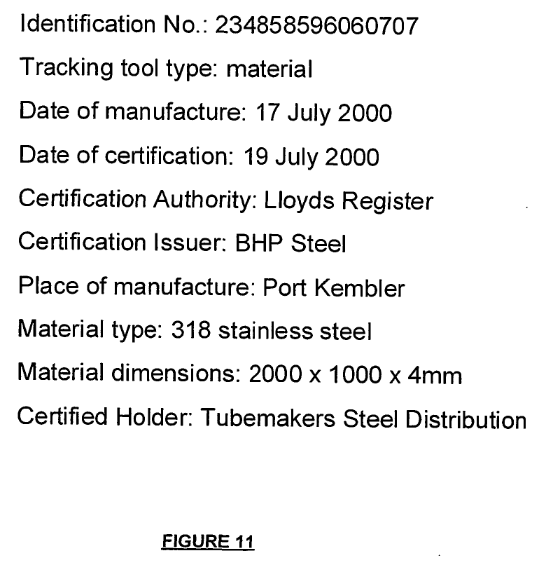

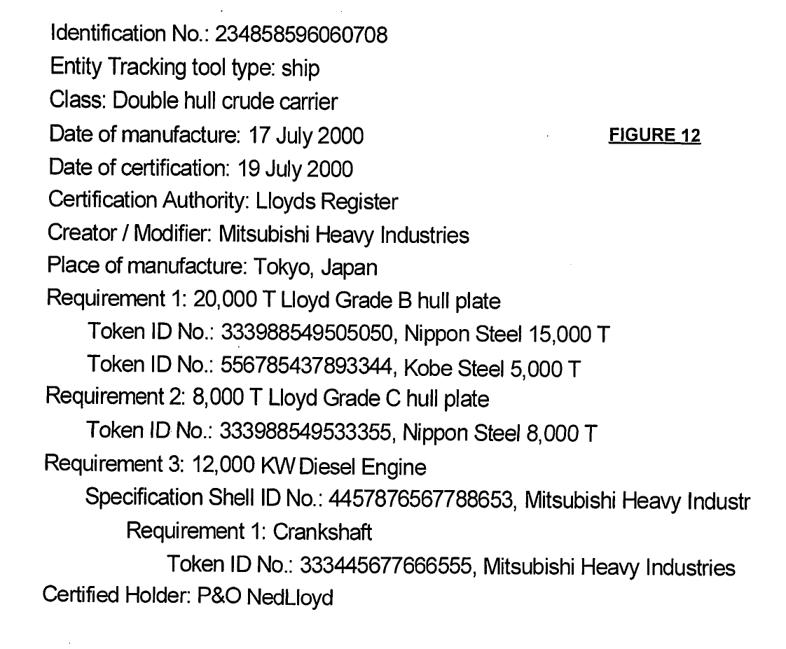

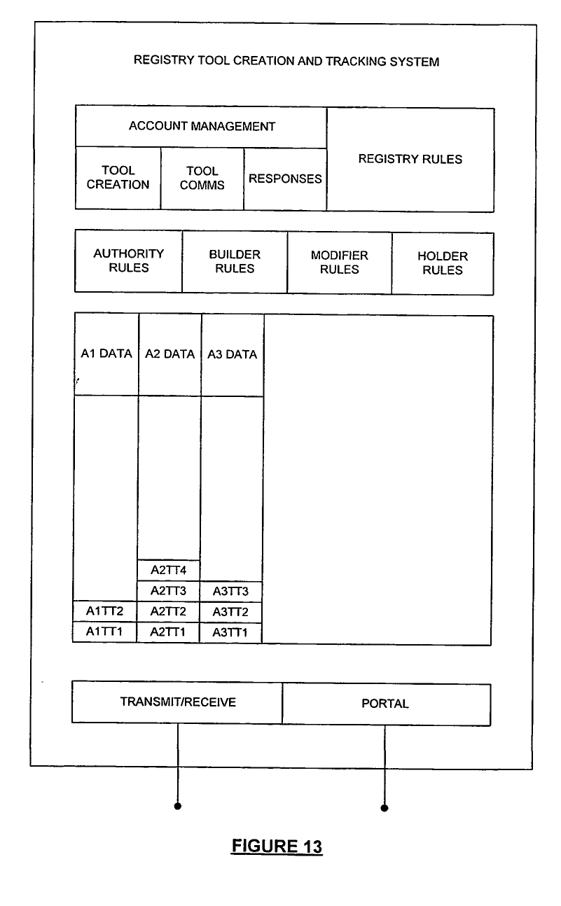

FIGS. 10a and 10b indicate shell tools before and after a process of modification and alteration, such as might occur when an object or entity is reclassified, or a standard relating to the assets is changed. Shell 3 in FIG. 10a represents an entity formed by integration of two other entities represented by shells 1 and 2, and an object represented by a token. The respective entities were each created by integrators 1, 2, 3 as indicated, and the object originated with a producer. In FIG. 10b a change by the authority in relation to shell 2 has required a modifier to alter the data relating to that shell, and to incorporate the object represented by the token. The modifier changes shell 3 and notifies the registry accordingly, and may now transfer the combined entity to another party, with shell 3. For example, a ship may be returned to the original holder.

FIGS. 11 and 12 provide simple examples of a token and shell respectively, such as might be created in relation to tracking of assets in the shipping industry. In each case the tool has an identification number and type usually determined by the registry before transfer to a certification authority. Data added by the authority may include the name of the authority itself and other details specific to the asset and the tool that will be transferred to a particular producer or integrator. In turn the producer or integrator add details including a date of manufacture, and date of issue of the token or shell representing certification. Also details relating to the nature of the object or entity itself, such as dimensions or component objects or entities. A producer will also normally add detail of a subsequent participant such as a distributor. The integrator will normally add detail of a subsequent holder such as an operator. Many details may ultimately be contained in the tool. Equivalent details will generally be held at the registry, along with transactional history and perhaps maintenance information.

FIG. 13 schematically shows a computer system that might be operated by a registry organisation for tool creation and tracking in systems such as those described above. The system could exist in many forms with software to provide this functionality, such as a single terminal, or a network of terminals and servers, depending on the size of the registry. An account management function is generally required to enable human operators to interact with the system, setting up records for new participants and carrying daily requirements. A collection of rules must also implemented by the registry and various participants, in order to implement reliable manipulation of the tools and other aspects of tracking, and these also will normally be accessible for operation of the system. A tool creation function is normally required for the registry to create and issue tools to authorities, preferably in the form of electronic documents. More sophisticated tools may involve digital signatures and perhaps software. A general communication function may also be required for receipt of notifications from the participants in relation to transfers, so that records of the tools can be updated, and indications of transactions and confirmations can be monitored. A response function which receives and answers enquiries from other parties regarding status of tools that currently operative in the system, and their corresponding assets is also normally required.

The registry system in FIG. 13 maintains a database or other storage subsystem with records of tracking tools that have been created and issued to particular authorities. Three authorities A1, A2, A3 are indicated in this example, each with a small number of tools that have been created and issued into the tracking system. Authority A1 has two tools TT1 and TT2, for example. In practice the database would records many thousands of tools that might be distributed around the world at a particular instant. The records are updated by communication with the participants as tools and assets are transferred or otherwise altered in commerce, or in related activities. In some cases tools may be deleted depending on the fate of their corresponding assets, or repaired depending on possible corruption in the field. Communication may be made available in a variety of ways, preferably by way of Internet connections, so that notifications may be sent from participant systems by way of email for example. Encryption and decryption are readily provided. Alternatively by way of portals through which relatively less sophisticated participant systems can access and update records directly, by way of a web browser for example.

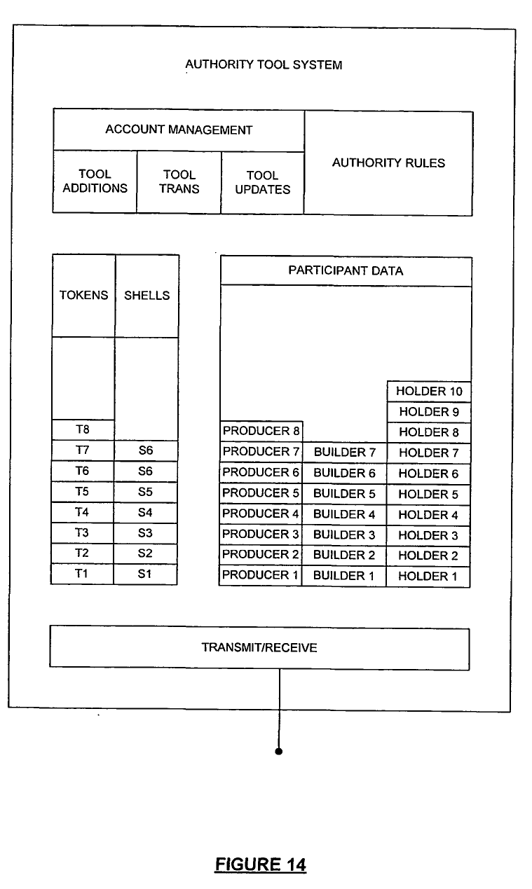

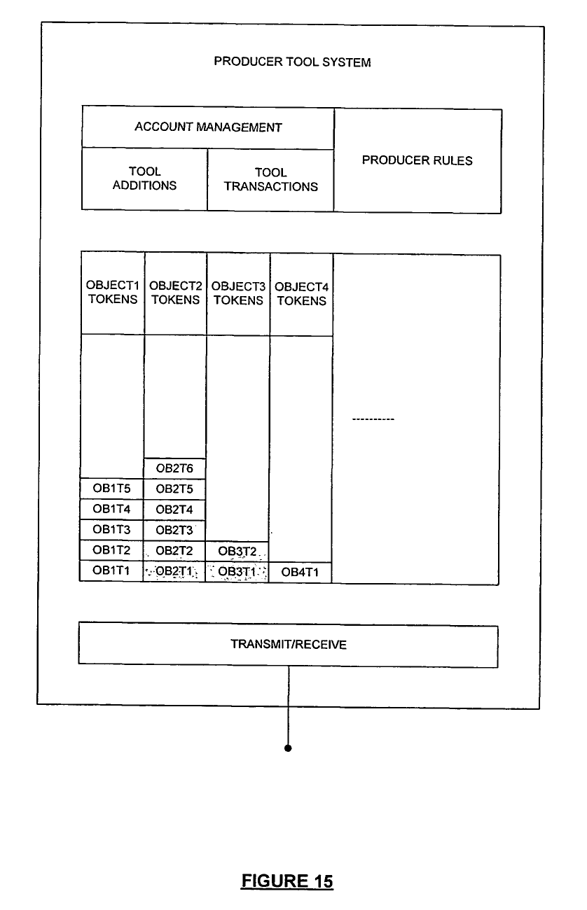

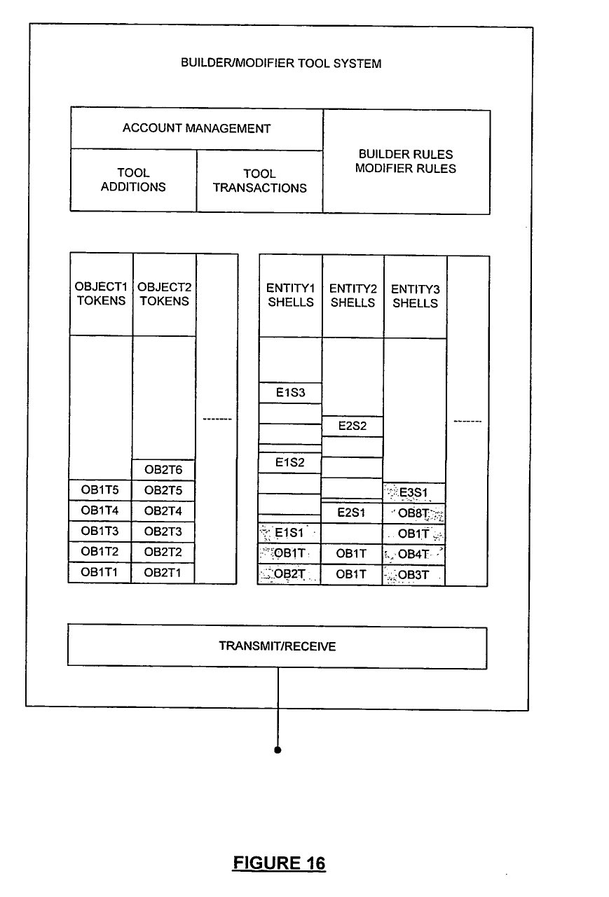

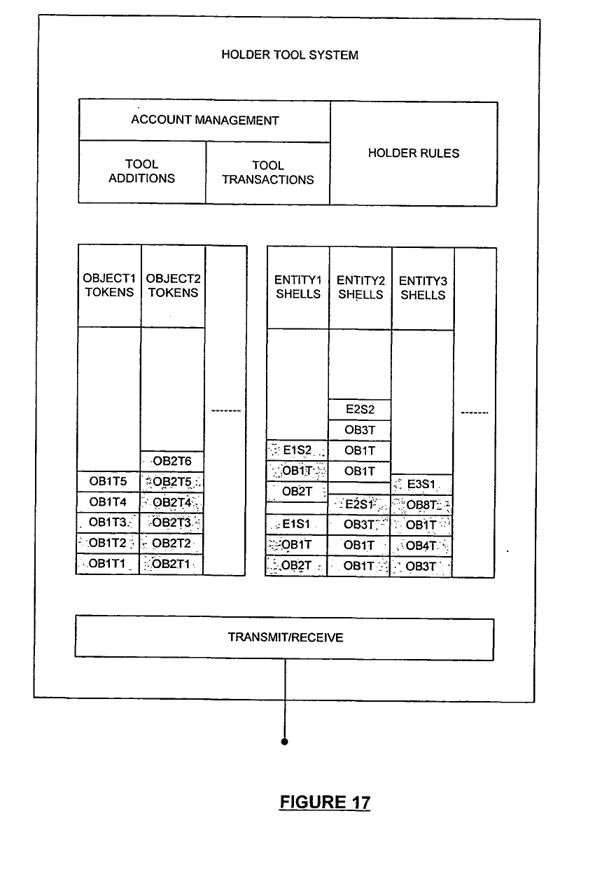

FIG. 14 schematically shows a computer system that might be operated by an authority organisation when participating in a tracking system. The authority would normally require functionality including account management and access to rules, and basic tool operations that enable customisation of tools for issue to particular producers or integrators, communication of notifications to and from registry and other participants, and tool updates such as may be required when classifications or standards are changed. The extent of these functions is limited to those permitted by the registry or general rules of the authority, and usually determined by licensed software. The authority would normally operate a secure storage system containing tools such as tokens and shells that have been received from the registry, or perhaps several registries, depending on the number of tracking systems in which the authority may be a participant, or the number of registries in a particular tracking system. In this case the authority system stores a small number of tokens and shells. Authority systems would also normally store data relating to other participants such as producers or issuers, integrators or builders, and holders. This enables appropriate customisation of tools according to specific requirements. In this case also the authority system communicates by way of an encryption receive/transmit subsystem. FIG. 15 schematically shows a computer system that might be operated by a producer/issuer organisation when participating in a tracking system. The producer would normally require functionality including account management and access to rules, as with most participants. Additions to tools received from authorities must be enabled in order to produce certificates as required for particular objects, or generally to add data to tools before transfer to other parties. Communication of notifications to the registry and other parties is also normally required. The extent of these functions is limited to those permitted by the registry or general rules of the producer, and are usually determined by licensed software. Many functions such as notification to the registry are automated. The producer would generally store a range of tokens, generally in an encrypted database, representing objects at different stages of production. In this case, there are four bins for tokens relating to objects of four types, although many more would be present in practice. Tokens shown light have been received and are ready to be used as objects are created. Tokens shown grey represent objects that are ready for despatch, perhaps with data having been added in relation to the receiving participant.

FIG. 16 schematically shows a computer system that might be operated by an integrator or modifier organisation when participating in a tracking system. The participant would normally require functionality including account management and access to rules, as with most participants. Additions to tools received from authorities must be enabled in order to produce and maintain certificates as required for particular objects, or generally to add data to tools before transfer to other parties. Communication of notifications to the registry and other parties is also normally required. The extent of these functions is limited to those permitted by the registry or general rules of the builder or modifier, and are usually determined by licensed software. Many functions such as notification to the registry are automated. The participant would generally store a range of tools, including tokens and shells, generally in an encrypted database, representing objects entities at different stages of production. In this case, there are two bins for tokens relating to objects of two types, and three bins for shells, although many more of each type would be present in practice. Only simple examples have been given as usual. Tools shown light have been received and are ready to be linked with entities that have yet to created. Tools shown grey represent entities that are ready for despatch, perhaps with data having been added in relation to the receiving participant.

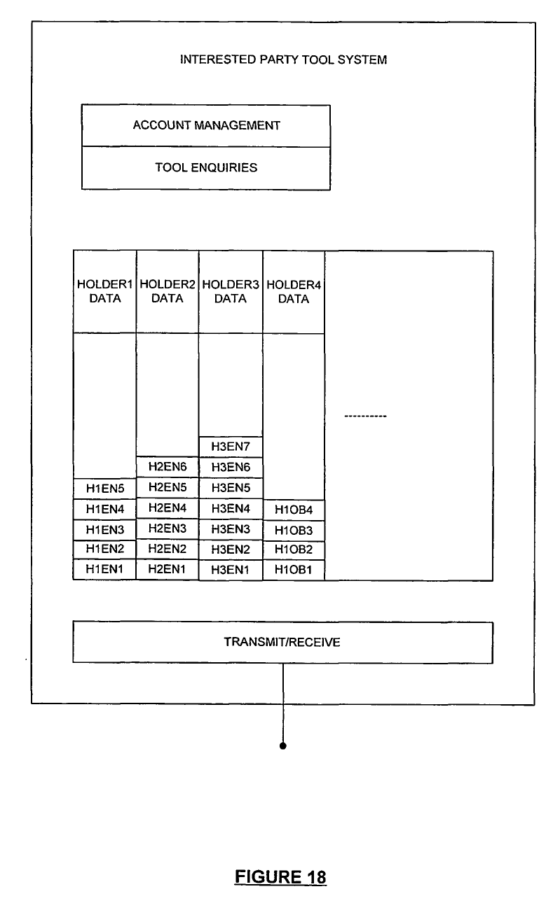

FIG. 17 schematically shows a computer system that might be operated by a holder organisation when participating in a tracking system. A holder would normally require functionality including account management and access to rules, as with most participants. Additions to tools received from authorities must be enabled in order to produce certificates as required for particular objects, or generally to add data to tools before transfer to other parties. Communication of notifications to the registry and other parties is also normally required. The extent of these functions is limited to those permitted by the registry or general rules of the holder, and are usually determined by licensed software. Many functions such as notification to the registry and other participants are automated. The holder would store a range of tools, including tokens and shells, generally in an encrypted database, representing objects entities in possession or operation. In this case, there are two bins for tokens relating to objects of two types, and three bins for shells, although many more of each type would be present in practice. Only simple examples have been given as usual. Tools shown light represent assets have been received and not currently intended for other parties. Tools shown grey represent assets that are ready for despatch to another participant, generally with data having been added in relation to that participant.

FIG. 18 schematically shows a computer system that might be operated by an interested other party when acting in relation to a tracking system. An assessor, for example, would normally require functionality including account management in order to deal with a range of assets, and in order to generate queries for participants and the registry. The assessor would normally store data relating to assets in the possession of holders, including information extracted from tokens and shells, perhaps in an encrypted database. In this case, there are four data bins for assets held by four different holders. Data may be received from the holders and or the registry, and a function for comparison of information may be provided. Communication with the participants takes place as usual, preferably through an encryption-decryption subsystem.

1. A registry system for tracking characteristics of assets produced and transferred by participants in commerce, comprising:
a creation subsystem that creates and issues tracking tools as required by participants that initially hold the tools,
a storage subsystem that records information relating to tools which have been issued by the creation subsystem, and subsequently modified and/or transferred among participants in relation to the assets,
a tracking subsystem that communicates with participants in relation to modification or transfer of tools and assets, and updates the storage subsystem, and
a response subsystem that provides information to participants or other parties on request in relation to the current status of tools and characteristics of respective assets.

2. A system according to claim 1 wherein:
the creation subsystem creates each tool with initial information relevant wholly or primarily to the participant that initially holds the tool.

3. A system according to claim 1 wherein:
the storage subsystem contains information that is substantially identical to information contained in the tools, and contains additional information relating to production, transactions or maintenance of the assets.

4. A system according to claim 1 wherein:
the tracking subsystem receives notification of changes in the tools made by the participants during production, modification and transfer of the respective assets.

5. A system according to claim 1 wherein:
the response subsystem provides information from the storage subsystem relating to current status of the tools and characteristics of the assets.

6. A system according to claim 1 wherein:
the tools certify information relating to respective assets or combinations of assets.

7. A system according to claim 1 wherein:
the tools may be modified in commerce according to division or combination of respective assets, and/or change of standards which relate to the assets.

8. A system according to claim 1 wherein:
the assets include materials, goods, services, legal rights, educational qualifications, financial instruments, software applications, or entities formed by integration of these assets.

9. A system according to claim 1 wherein:
the participants include classification or standards authorities, producers, integrators, modifiers and/or operators of goods or services.

10. A participant system for use in tracking characteristics of assets in commerce, comprising:
a storage subsystem that holds tracking tools representing assets currently possessed by the participant,
a transfer subsystem that receives and transmits tracking tools in relation to transfer of the assets to and from other participants, and
a notification subsystem that communicates changes in the tracking tools made by the participant to a registry.

11. A system according to claim 10 wherein:
the tools include tokens that represent objects or shells that represent combinations of objects.

12. A system according to claim 10 wherein:
the participant is a producer of objects and the storage subsystem holds only tokens relating to objects.

13. A system according to claim 10 wherein:
the participant is a creator or modifier of entities and the storage subsystem holds tools relating to both objects and entities.

14. A method of tracking characteristics of assets in commerce comprising:
creating and issuing tools as required by participants that initially hold the tools before allocation to assets,
storing information in a registry concerning the tools that have been created and issued,
receiving information in relation to creation, modification and/or transfer of the assets and tools among participants, and
providing information from the registry to other parties in relation to current status of the tools and characteristics of the assets.

15. A method for a participant in a tracking system comprising:
storing tracking tools representing assets currently possessed by the participant,
transmitting tracking tools in relation to transfer of the assets to and from other participants, and
notifying a registry regarding changes in the tracking tools made by the participant.
